(19) United States
(12) Patent Application Publication
(10) Pub. No.: US 2009/0207869 A1
(43) Pub. Date: Aug. 20, 2009

(54) LASER PLASMONIC SYSTEM

(75) Inventors: Marcos Dantus, Okemos, MI (US); Jess M. Gunn, East Lansing, MI (US)

Correspondence Address: HARNESS, DICKEY & PIERCE, P.L.C., P.O. BOX 828, BLOOMFIELD HILLS, MI, 48303, US

(73) Assignee: BOARD OF TRUSTEES OF MICHIGAN STATE UNIVERSITY, EAST LANSING, MI (US)

(21) Appl. No.: 12/373,996

(22) PCT Filed: Jul. 18, 2007
(86) PCT No.: PCT/US07/16274

§ 371 Date: Jan. 15, 2009

Related U.S. Application Data
(60) Provisional application No. 60/832,032, filed on Jul. 20, 2006.

(51) Int. Cl. H01S 3/10

(52) U.S. Cl. 372/21; 372/25

(57) ABSTRACT

The present invention can selectively control surface plasmon-mediated two-photon-induced luminescence in a dendritic silver nanoparticle system over distances of up to 100 m. This control is achievable by changing the polarization of the incident beam and by controlling the phase across the spectrum of a femtosecond laser pulse used for excitation. Furthermore, the present invention uses the phase and polarization dependence to address photonically locations within substantially 100 m from the focal spot.

### CROSS REFERENCE TO RELATED APPLICATION

This application claims priority to U.S. Provisional Patent Application Ser. No. 60/832,032, filed on Jul. 20, 2006, which is incorporated by reference herein.

### STATEMENT OF GOVERNMENT INTEREST

A portion of this invention was made with U.S. Government support under Contract No. 61-3237 awarded by the U.S. Department of Energy. The U.S. Government may have certain rights in this invention.

### BACKGROUND

The present invention generally pertains to laser plasmonic systems and more particularly to polarization and phase control of surface plasmon waveguiding.

Metallic nanoparticles have been studied extensively throughout recent history in an effort to understand both their unique emissive properties, as seen for example in stained glass, and their more recently discovered ability to localize and enhance electromagnetic fields. It is known that pyridine adsorbed on a roughened silver electrode produced a Raman spectrum 10⁵-10⁶ times greater than would be expected. This effect, now known as surface enhanced Raman scattering (hereinafter “SERS”) is due to nanoscale structures produced by roughening, and their ability to localize surface plasmons into ‘hot spots’ or regions of amplified electromagnetic (hereinafter “EM”) field. The localization of surface plasmons has also been used to enhance multiphoton processes.

This localized surface plasmon (hereinafter “LSP”) resonance has led to a wide variety of applications. It made possible the first room-temperature optical detection and SERS spectroscopy of single molecules, and has allowed for low threshold lasing of dyes. Individual nanoparticles can be used as biosensors with zeptomolar sensitivity, and nanowire bundles can be used to direct analytes into regions with a localized and amplified EM field.

Furthermore, “long-distance” propagation of surface plasmons can occur via surface plasmon waves (hereinafter “SPWs”). Work has been done to design waveguides and develop structures that act as mirrors and beamsplitters for SPWs. SPWs have also been used to mediate fluorescence resonance energy transfer (hereinafter “FRET”) over 120 nm by sandwiching a thin silver film between the donor and acceptor molecules. In dendritic nanoparticle structures, both local and long distance effects are possible because of the two types of surface plasmons: SPWs, which propagate along the metal surface, and LSPs, which are confined to metal nanoparticles. The combination of these two types of surface plasmons allows EM radiation incident on a dendritic structure to propagate away from the focal spot along the surface (via SPWs) and then localize in a particular region (via LSPs). The difficulty in exploiting nanostructures that support both SPWs and LSPs is in controlling how the energy travels and where it localizes.

### SUMMARY

In accordance with the present invention, a laser plasmonic system is employed. Another aspect of the present invention provides a laser beam and a carrier where an emission occurs downstream of a focal point of the laser beam. An additional aspect of the present invention provides two-photon-induced luminescence in a sample. In another aspect of the present invention, luminescence occurs distant or remotely from the focal point. A further aspect of the present invention uses polarization and phase control of surface plasmon waveguiding. In another aspect of the present invention, the control of two-photon-induced luminescence of silver nanoparticle clusters is provided. By using a femtosecond laser focused down to ˜0.5 μm, emission via surface plasmons should be observable up to 100 μm from the focal spot. The regions of emission can be controlled by changing the polarization of the incident beam and by changing the spectral phase across the spectrum of the laser pulse. Moreover, an aspect of the present invention employs the laser pulse in communications and/or on a microchip. A method of using a laser plasmonic system is also provided.

The experimental realization of the control of the present invention is expected to lead to advancements in surface plasmon-based photonics (hereinafter “plasmonics”). This is advantageous by bridging the gap between optics and electronics through carefully designed wires capable of carrying both electronic and optical signals over centimeter distances. The present invention can selectively control surface plasmon-mediated two-photon-induced luminescence in a dendritic silver nanoparticle system over distances of up to 100 μm. This control is achievable by changing the polarization of the incident beam and by controlling the phase across the spectrum of a femtosecond laser pulse used for excitation. Furthermore, the present invention uses the phase and polarization dependence to address photonically different locations within substantially 100 μm from the focal spot. Additionally, it is expected that the present invention system includes silver particles that will enhance two-photon fluorescence. The present invention laser plasmonic system is also advantageous over prior devices since the present invention is highly controllable and reproducible. The present invention system also provides the ability to measure the spectral phase at various points of localization as well as identify which part of the laser beam the nanoparticle is primarily interacting with. Additional advantages and features of the present invention will become apparent from the following description, taken in conjunction with the accompanying drawings.

### BRIEF DESCRIPTION OF THE DRAWINGS

FIG. 1 is a diagrammatic perspective view showing the preferred embodiment equipment used in a laboratory with the laser plasmonic system of the present invention;

FIGS. 2a-d are electron microscopy images showing nanoparticles used with the preferred embodiment laser plasmonic system;

FIGS. 3a and b are graphs showing expected two-photon luminescence of silver nanoparticles used with the preferred embodiment laser plasmonic system;

FIG. 4 is an illustration of an expected remote emission used with the preferred embodiment laser plasmonic system;

FIGS. 5a-d are illustrations expected from characterizing the polarization properties of remote emissions used with the preferred embodiment laser plasmonic system;

FIG. 6 is a set of graphs and images expected for phase control of remote emissions and various pulse phase functions used with the preferred embodiment laser plasmonic system;

FIG. 7 is a partially schematic view showing the preferred embodiment laboratory equipment of the present invention laser plasmonic system;

FIG. 8 is a diagrammatic view showing the energy transfer mechanism employed in the preferred embodiment laser plasmonic system;

FIG. 9 is a graph showing expected spectra of emission used with the preferred embodiment laser plasmonic system;

FIG. 10 is a graph showing expected phase functions used with the preferred embodiment laser plasmonic system;

FIG. 11 is a graph showing a collected image of emission used with the preferred embodiment laser plasmonic system;

FIGS. 12a and 12b are graphs showing simulations of integrated second harmonic intensities used with the preferred embodiment laser plasmonic system;

FIGS. 12c and 12d are graphs showing expected intensities of emission used with the preferred embodiment laser plasmonic system;

FIG. 13 is an exaggerated perspective view showing a varied embodiment of the equipment used in a commercial communications system with the laser plasmonic system of the present invention;

FIG. 14 is a diagrammatic view showing the FIG. 13 embodiment of the equipment used in a commercial communications system with the laser plasmonic system of the present invention; and

FIG. 15 is a diagrammatic view showing another varied embodiment of the equipment used in a commercial communications system with the laser plasmonic system of the present invention.

### DETAILED DESCRIPTION

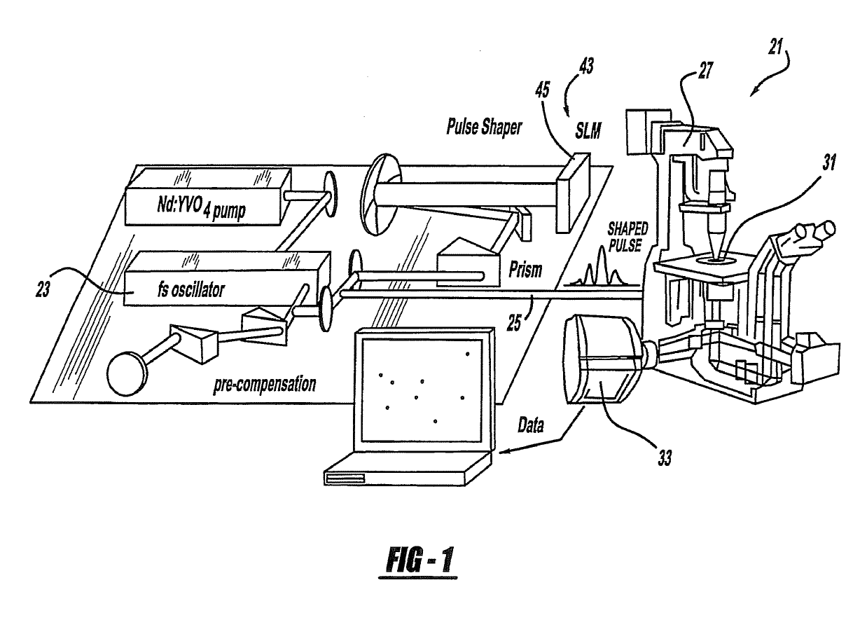

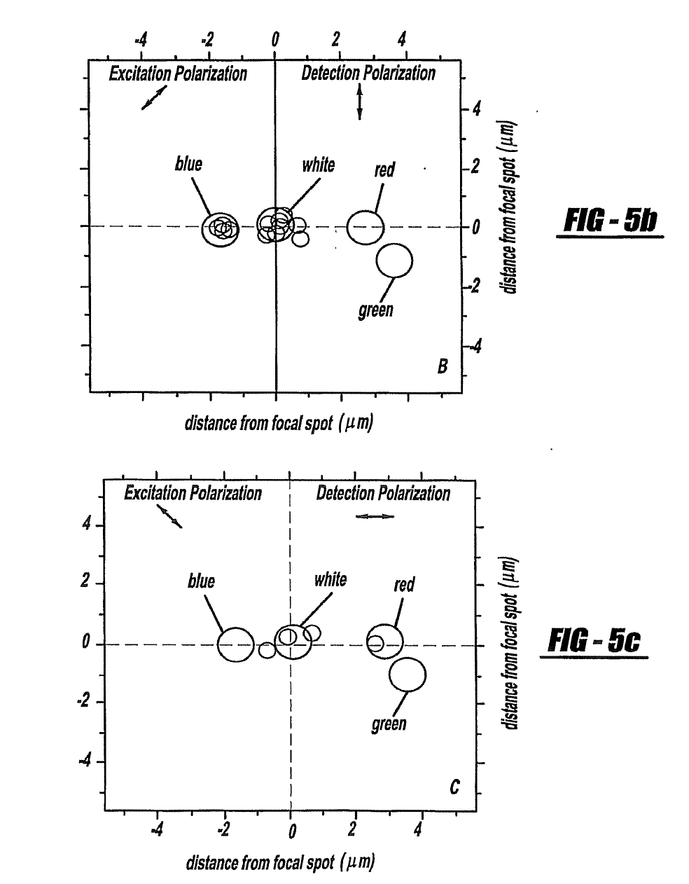

Referring to FIGS. 1 and 7, the preferred embodiment of a laser plasmonic system 21 used in a laboratory employs a titanium sapphire laser oscillator 23 capable of producing 10 fs pulses b 25 (100 nm FWHM) centered near 800 nm, with a repetition rate of 97 MHz and 250 mW average power coupled with a Nikon TE2000 U inverted microscope 27. A Nikon Plan Apo 60×/1.45 NA objective 29 is used to focus the beam onto the sample 31, which rests on a piezoelectric nanopositioning stage. The emitted light is then imaged by an electron multiplier CCD camera 33. A short-pass (650 nm) dichroic mirror 41 prevents detection of laser-scattered light (700-900 nm). A pulse shaper 43, incorporating a liquid-crystal spatial light modulator 45, is used to control the spectral phase of the laser pulses. A multiphoton intrapulse interference phase scan (hereinafter “MIIPS”) method is used to eliminate linear and higher-order phase distortions to deliver transform-limited (zero-phase) pulses at the focus of the microscope objective, facilitating the use of coherent control. The MIIPS apparatuses and methods are disclosed in U.S. patent application Ser. No. 11/177,940 entitled “Control System and Apparatus for Use with Ultra-Fast Laser” and U.S. patent application Ser. No. 10/265,211 entitled “Laser System Using Ultrashort Laser Pulses,” both of which were invented by M. Dantus et al. and are incorporated by reference herein. The apparatus of the present invention is depicted in FIGS. 1 and 7 which show a laboratory setup for femtosecond laser scanning microscopy with pulse shaping capabilities.

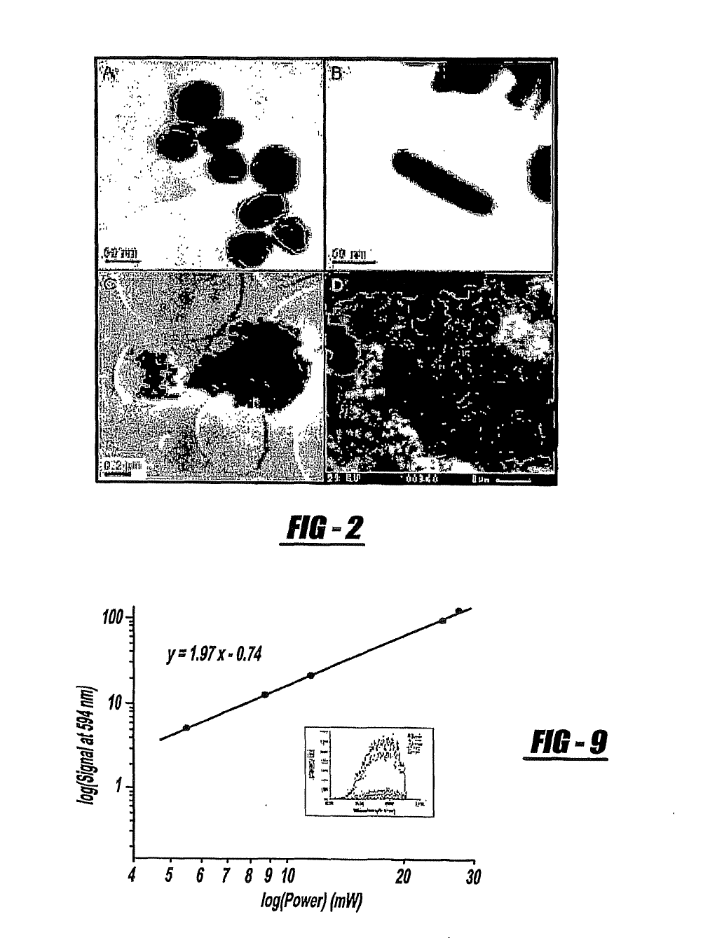

Sample 31 includes dendritic nanowires on a cover slip. The nanowires are preferably made from silver nanoparticles which are synthesized by a citrate reduction, and cluster formation is induced by the addition of fumaric acid. The clusters precipitate onto the quartz cover slips over 60 hours. The cover slips are then removed from the solution, rinsed in MilliQ water, and allowed to dry. Electron microscopy images are obtained in order to characterize the nanoparticle samples. FIGS. 2a-c show transmission electron microscopy (hereinafter “TEM”) images expected from the samples, while FIG. 2d shows a scanning electron microscopy (hereinafter “SEM”) image also expected. The TEM images indicate that the nanoparticles form both as roughly spherical structures (FIG. 2b) and as rods (FIG. 2c), with dimensions on the order of 50 nm, while the SEM image shows the dendritic nature of the nanoparticle film.

For thin films of silver nanoparticle aggregates, the intensity of the excitation beam must be high enough to induce observable emission, but low enough that the sample is not irreparably damaged. Empirically, average powers as low as 2 μW (˜707 W/cm² average power; 7.28×10⁹ W/cm² peak power) are capable of causing irreversible damage to the sample after even one scan. For samples with good plasmonic waveguiding, powers are reduced to ˜1 mW and well tolerated.

Excitation of these films of silver nanoparticles results in intense luminescence due to LSP resonance. The luminescence appears consistent with two-photon-induced surface-plasmon mediated fluorescence of silver oxide on the surface of the silver nanoparticle films. This is supported by a power study of silver nanoparticles in solution, in which a quadratic dependence of the signal on pulse intensity is shown in FIG. 3. The expected spectra shown in FIG. 3 are for silver nanoparticles prepared under air. Solutions of silver nanoparticles prepared under N₂ should have similar emission spectra with slightly lower overall intensities. FIGS. 3a and 3b show two-photon luminescence of silver nanoparticles in solution. FIG. 3a shows the expected emission spectrum at different incident powers and FIG. 3b shows an expected log-log plot of the emission intensity versus power. The slope near 2 indicates the process is a two-photon process. The sharp cutoff at 650 nm in FIG. 3a is due to the cutoff filter used to separate the incident beam from the emission.

Thin films of silver nanoparticle clusters should amplify the two-photon-induced fluorescence emission from a dye-doped polymer thin film. When performing a similar experiment utilizing a rhodamine 590-doped thin film of poly(vinyl alcohol), the amplification of the rhodamine-590 emission can be attributed directly to the luminescence of the silver nanoparticle clusters themselves. That is, through comparison of average peak intensity of a film of rhodamine-590, a film of silver nanoparticle clusters, and a film of the two together, a simple addition of the signal from the two former leads to the signal of the latter. In other words, any increase in signal when comparing rhodamine and rhodamine with silver nanoparticles can be attributed to luminescence directly from the silver nanoparticles and not to an amplification of rhodamine fluorescence.

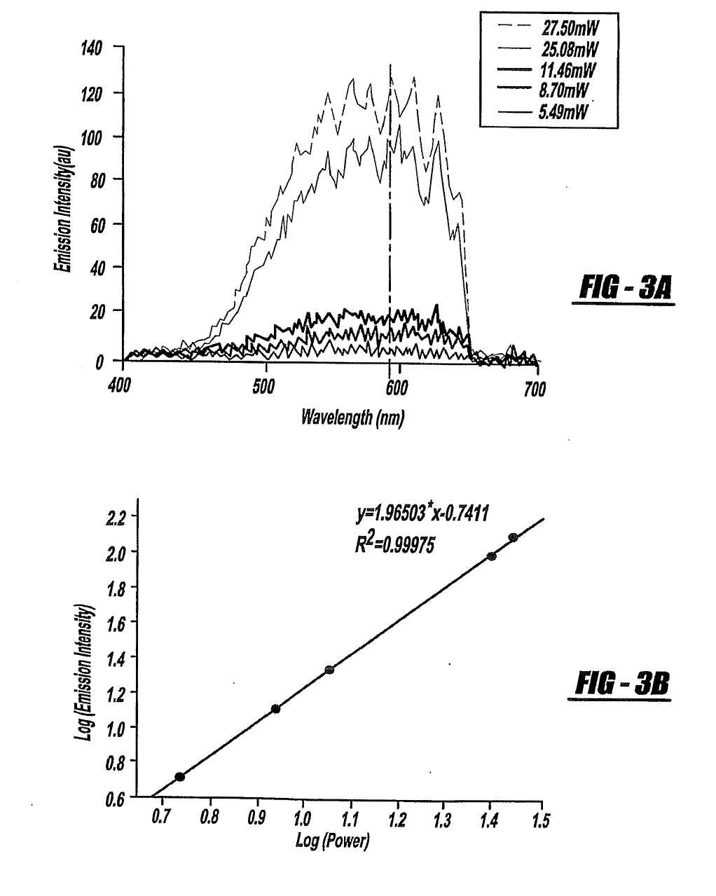

When exciting the thin films of silver nanoparticle clusters at a single point, with a focal spot diameter of ˜0.5 μm, relatively intense, highly localized emission should be observable tens of microns away. This is illustrated in FIG. 4, where the focal spot is located at (0,0), indicated by the crosshairs, and two-photon induced emission from the silver nanoparticles is observed more than 40 μm from the focal spot. Note that many areas of remote emission are more intense than the emission observed at the focal spot.

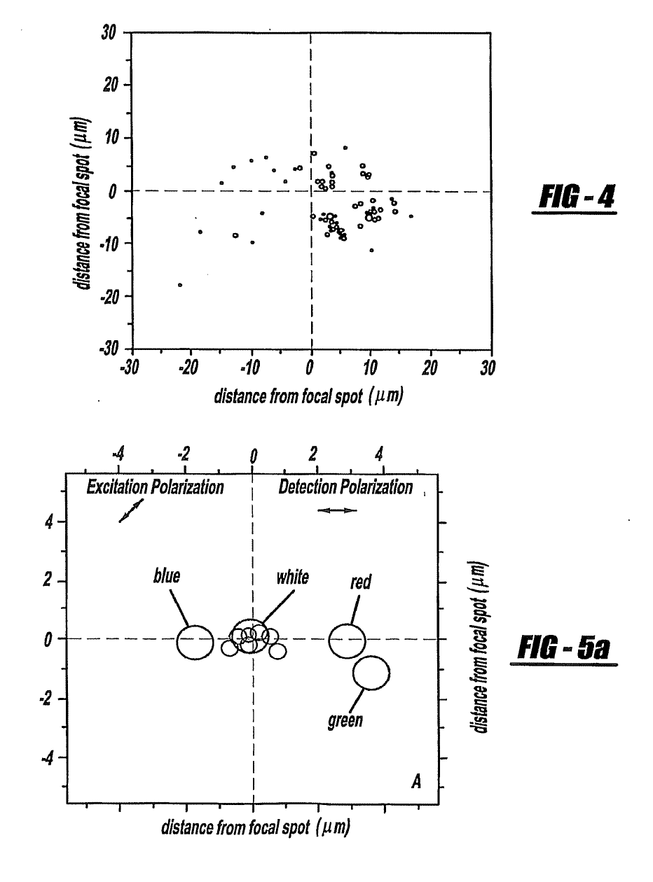

FIG. 5 illustrates the present invention system characterizing the polarization properties of remote emission, as well as controlling the regions of emission. Both the remote and local (at the focal spot) emissions are polarized, and the polarization of the incident beam is not always conserved, nor is the polarization of each region of emission the same. Each image of FIGS. 5a-d is an expected wide-field image of the same area under different polarization conditions for excitation and emission. FIGS. 5a and b are excited with a beam of 45° polarized light, while FIGS. 5c and d are excited with a beam of 135° polarized light. Expected horizontally polarized emission is detected in FIGS. 5a and c, and vertically polarized emission is detected in FIGS. 5b and d. It can be seen from this figure that the emission is polarized, with the spots not all having the same emission polarization. For example, the area in the blue ring emits distinctly vertically polarized light for both excitation polarizations, while the region ringed in red emits horizontally polarized light. Even the region at the focal spot does not necessarily maintain the polarization of the excitation beam. Additionally, polarization of the excitation beam can be used to control the presence or absence of emission in certain spots. This is clearly illustrated by the focal spot, ringed in white; but has also been observed for remote emission. The relative intensities of regions of remote emission can also be controlled by changing the phase applied across a transform-limited pulse.

A number of methods to control nonlinear optical excitation based on phase-shaped femtosecond laser pulses can be used. The influence of phase-shaped pulses on the two-photon remote luminescence exhibited by dendritic silver nanoparticles will be disclosed hereinafter. Referring to FIG. 6, phase control of remote emission is illustrated. FIG. 6 shows three wide-field images of the same region with a sinusoidal phase function obtained using phase-shaped femtosecond pulses with a sinusoidal phase function of the form 1.5π[sin(12(ω−ω₀)−δ)] applied across the spectrum of the laser pulse, where the frequency, ω₁ is in fs⁻¹. In these images, only the value of δ (in rad) is varied from panel to panel. Through comparison of the three panels of FIG. 6, it can be seen that emission from some areas is dependent on δ, whereas only the intensity of emission of other areas is dependent upon δ. Each lower panel is a wide-field image of the same region of the sample, with the focal spot at (0, 0). The phases (black line) applied across the spectrum of the pulse (red line) are shown above each image. The colored circles highlight regions of interest and are in the same position in each panel.

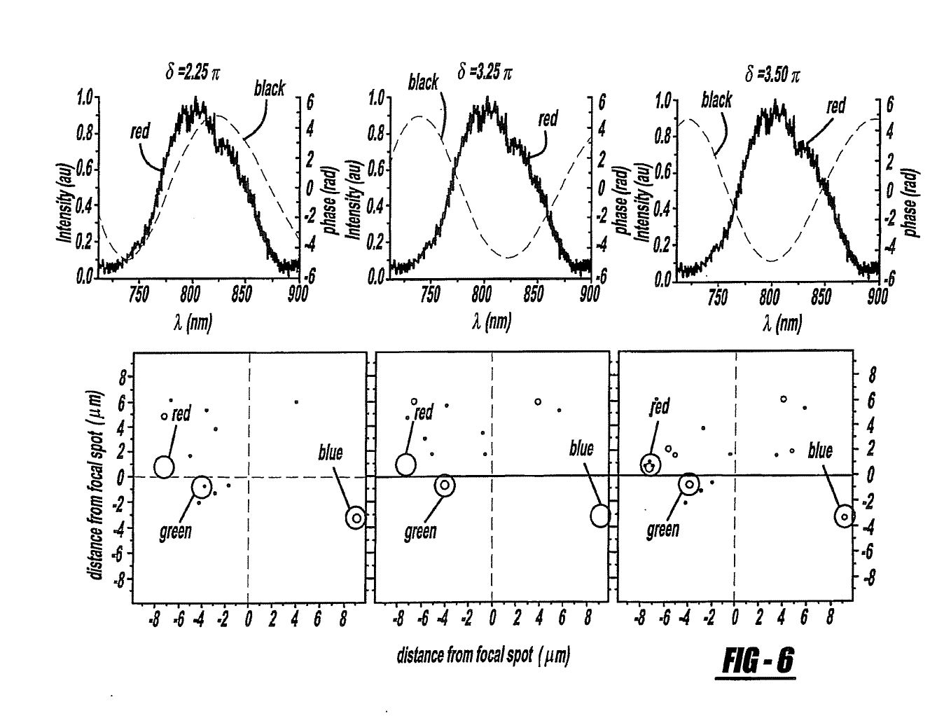

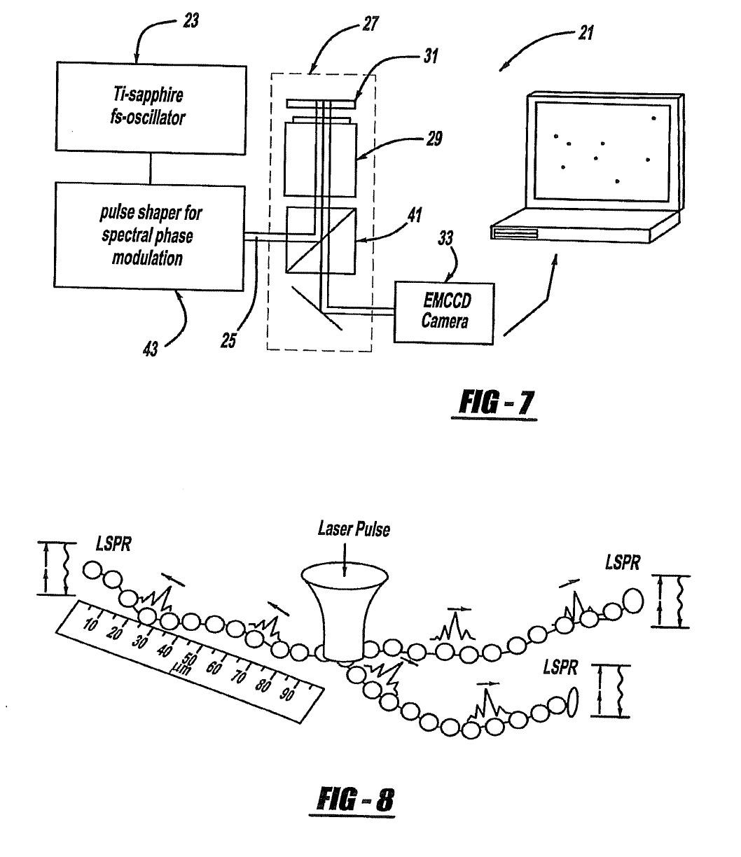

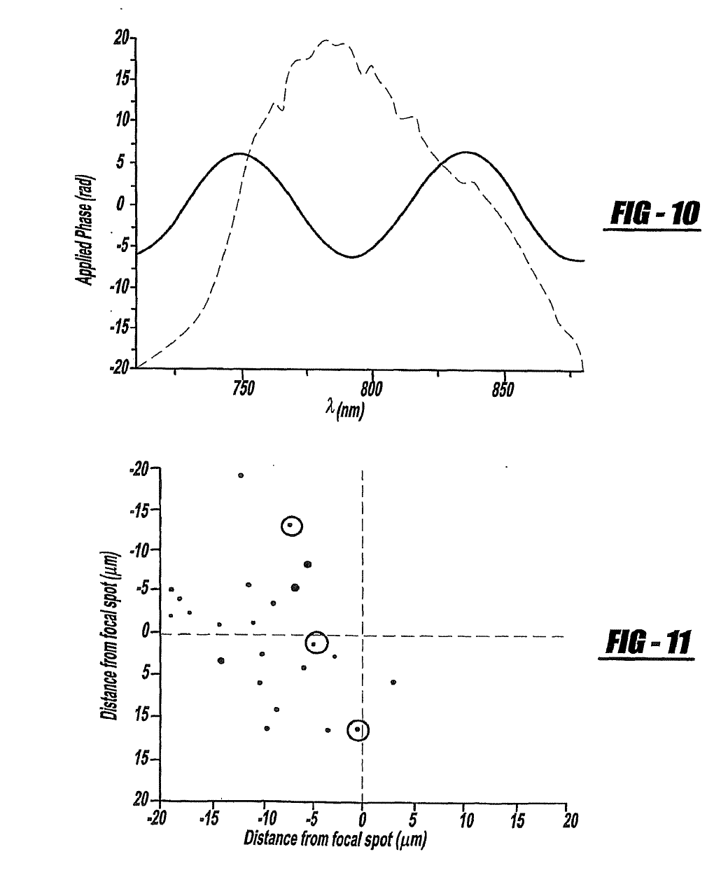

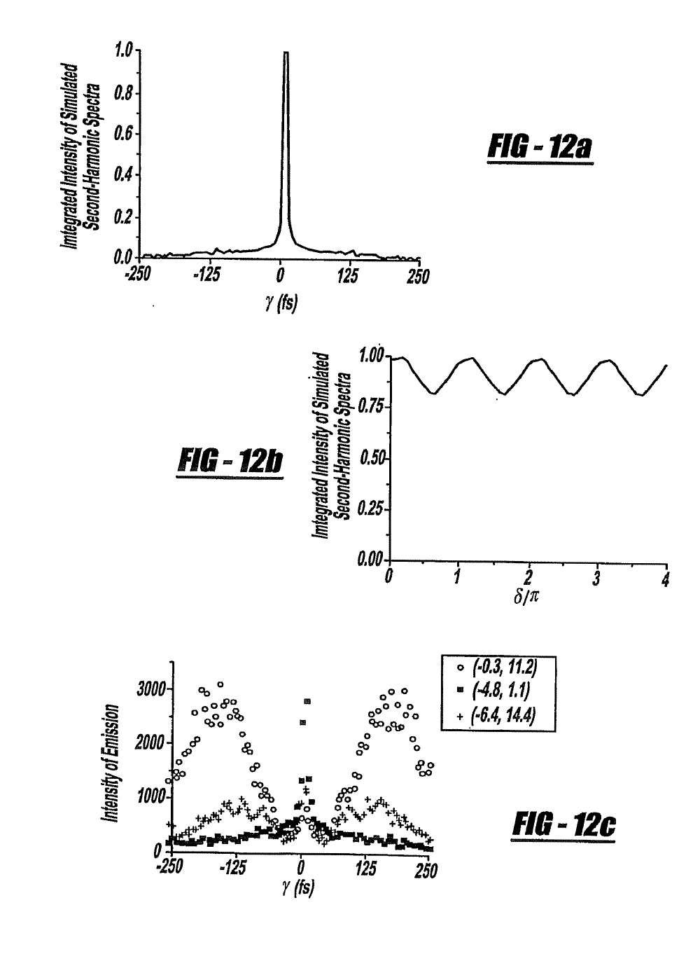

Regions of remote emission can be controlled by the spectral phase of the ultrashort laser pulses used for excitation. FIG. 10 shows expected results of the application of phase functions of the form 2π[cos(γ(ω−ω₀)−δ)] (illustrated as a solid line) across the spectrum of the pulse (illustrated as a dashed line), where ω is the frequency of the spectral component, in fs⁻¹. As viewed in FIG. 11, a collected image of emission when the silver nanoparticle thin film is excited with a femtosecond laser. The intensities of particular spots (shown circled) are plotted in FIGS. 12a-d as a function of phase. FIGS. 12a and 12b show the simulated, integrated second harmonic intensity of emission (as a function of phase) that would be expected if the excitation EM pulse is transform-limited (i.e. the sample introduces no dispersions). Furthermore, FIG. 12c shows the expected intensity of emission from the three different regions circled in FIG. 11 when δ is fixed to 0, and γ is scanned from −250 fs to +250 fs. The solid squares illustrate the data with the most ‘expected’ (i.e. transform-limited-like) behavior: a sharp peak at γ=0 (zero-phase) with intensity that decreases as the absolute value of γ is increased. A wide variety of behavior, however, occurs in other regions of emission, with an extreme case shown by the open circles in FIG. 12c, where the center peak has a very low intensity relative to the intensity at extreme γ values.

FIG. 12d shows the intensity of emission from these same three regions when γ is fixed to 15 fs and δ is scanned from 0-4π. Again, each point shows different behaviors. The solid squares illustrate different relative peak intensities, for example, and other points show asymmetries in the various peaks as well as variations in the peak spacing. The open circles in FIG. 12d again show the most extreme expected behavior, where two of the four expected peaks disappear altogether. This wide range of behavior can be quantified by fitting the data to simulations of the integrated second-harmonic-spectrum when the phase φ=2π[cos(15(ω−ω_{0,eff})−δ)]+½[β(ω−ω₀)²]+⅙[ε(ω−ω₀)³] is applied. The cosine term is the applied phase, while the β and ε terms quantify the second- and third-order dispersion (SOD and TOD, respectively) introduced as the energy travels through the sample. Both positive and negative values for both β and ε are observed, even within a single sample. The best-fit simulations for the three plotted data points are shown as lines in FIG. 12d. Accordingly, one aspect of the present invention laser plasmonic system employs dendritic silver nanoparticles with remote regions of emission that exhibit a wide range of responses to the application of a spectral phase. This presents the opportunity that particles or patterns of particles can be designed to have a pre-determined response to tailored laser pulses and achieve optically controlled switching.

The expected presence of remote emission, and the ability to control it via polarization and phase indicates that it is possible to control plasmonic propagation and emission over distances far greater than previously possible. With a laser focused to a 0.25 μm² region, localized emission over a 10³ μm area can be controlled. This four orders-of-magnitude control achieved with phase-shaped and polarized pulses may have great significance in the field of electronics, in which miniaturization of computer microprocessor or memory chips is limited by the size of (and subsequent heat loss due to) the wires used to transport electronic information. The development of plasmonic waveguides will allow for controlled transport of optical information along nanowires, lowering the size barrier currently faced.

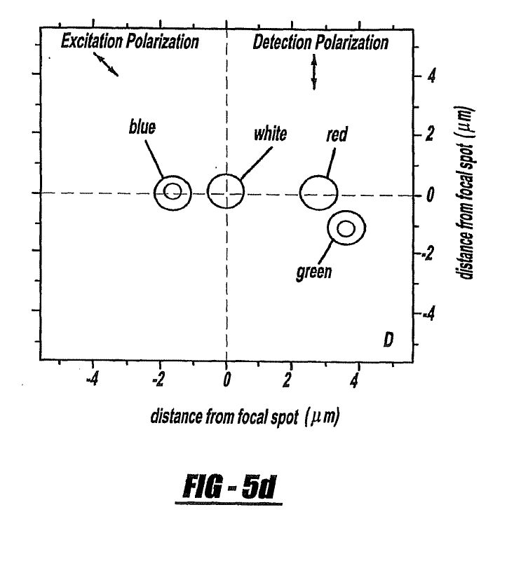

Referring to FIG. 8, when a femtosecond laser pulse centered at 800 nm is incident on a thin film of polydisperse silver nanoparticles, localized two-photon-induced fluorescence occurs at distances up to 99 μm from the focal spot. FIG. 8 schematically illustrates an energy transfer mechanism. The excitation pulse excites surface plasmons which propagate via coupling between particles before localizing at a particular particle. This localized surface plasmon resonance (hereinafter “LSPR”) results in two-photon-induced fluorescence.

Scanning a series of well-characterized spectral phase functions across the spectrum of a transform-limited excitation laser pulse and collecting two-photon-induced fluorescence from a thin, rough film of silver nanoparticles allow quantification of the second- and third-order dispersions introduced by the sample using far-field detection. While this approach uses spectral data for measuring the phase distortions inherent in a femtosecond laser pulse for the purpose of compensating those distortions via the MIIPS method, the integrated intensity of the regions of remote emission as a function of spectral phase can be used to simultaneously determine the second- and third-order phase distortions at each point in the sample.

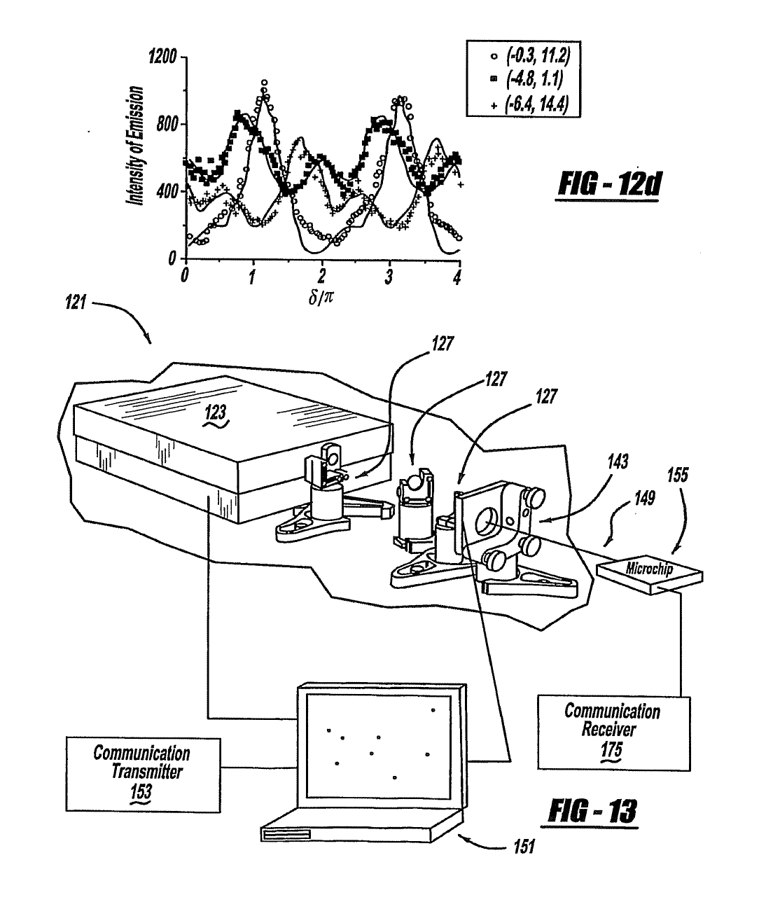

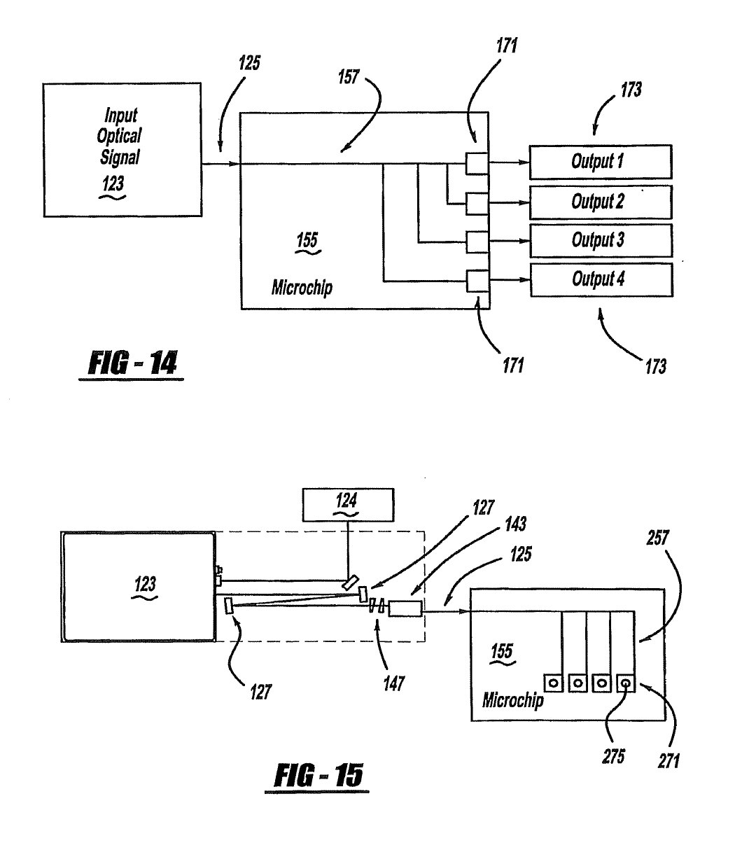

As can be observed in FIGS. 13 and 14, a commercial embodiment of the laser plasmonic system 121 is used for communications. A laser includes an oscillator 123, powered by a laser pump 124 (see FIG. 15), operably sends a laser beam pulse 125 to a series of dispersive mirror optics 127, and then through a deformable mirror pulse shaper 143 and extra cavity dispersion control lens 147 coupled to a fiberoptic cable 149. A Femtolasers Produktions GmbH Femtosource Scientific oscillator is preferred for this application due to its compact size and ability to generate pulses at or less than 10 femtoseconds at 800 nm. Nevertheless, pulse durations at or less than 20 femtoseconds are preferred, however, less than 1 pico Joule of energy is required. A programmable computer controller 151 employs MIIPS software instructions to automatically control pulse shaper 143 and optionally oscillator 123 in a real-time, feedback manner. A communications transmitter 153 is connected directly or indirectly to controller 151 in order to cause pulse emission and/or pulse shape characteristic changes depending on communication transmission signals desired to be sent. For example, the communications signals can be telephonic voice, computer created data, spacecraft satellite created optical or electromagnetic encoded data, or the like, wherein the pulse shaping characteristic is varied to match the signal differences.

A microchip 155 or the like is connected to fiber optic cable 149. Conductive nanowire carriers 157, created by a chain of adjacent nanoparticles, act as a nanoplasmonic waveguide. Nanowires 157 are preferably made of a silver based material placed onto or etched in a microchip, such as through e-beam lithography, with a single layer of magnesium oxide or similar dielectric material coating thereon to prevent oxidation. Each wire 157 is preferably 10-1,000 nm in thickness, 1-100 nm in width and less than 1 mm long. The shaped laser beam pulse will propagate as a surface plasmon wave but will cause an emission downstream of a focal point, located at an emitting nanoparticle of the carrier which is separated from the immediately upstream portion of the nanowire by a gap. The emitter gap or discontinuity is less than about one wavelength, such as less than 10 nm. In other words, the system excites and thereby creates a surface “wave” on the conductive nanoparticles forming the electrical/photonic circuit. The controller software and shaper control the nanoplasmonic waveguide emission location based on at least one or more of the following parameters: (a) input polarization and/or phase of the pulse; (b) wire dispersion characteristics, for example, positive or negative second- or third-order dispersion; (c) size, orientation and/or resonant frequency of the nanoparticle emitter; and (d) material composition of the nanoparticle emitter, for example, gold or silver.

More specifically, FIG. 14 illustrates the conductive nanowire network or circuit on microchip 155. Multiple branched nanowires 157 are interconnected and include emitter locations 171 located difference distances from a focal point of laser beam 125. Thus, nanowires 147 operably carry the laser beam pulse signals to emitters 171. An output device 173 is directly or indirectly connected to each emitter 171, and may be part of one or more communications receivers 175. Receivers are telephones, computer controllers, spacecraft electronics or the like.

Referring to FIG. 15, another embodiment of the present invention laser plasmonic system is similar to the prior communications embodiment except that conductive nanowires 257 carry the laser beam signals to emitters 271 and optoelectronic components 275 are directly or indirectly connected to emitters 271. Nonlimiting exemplary optoelectronics include infrared emitters, light emitting diodes, lamps, laser diodes, light pipes, optical switches, opto-transceivers, opto-couplers and the like. Accordingly, the emission downstream of the focal point of the laser beam pulse allows signals to be routed to designated targets, components or outputs on or connected to the microchip, or other conductive circuit.

Functionally, although the plasmonic wave signal travels in all direction, the emitter nanoparticle downstream of the focal point in the nanowire luminesces or activates according to phase and polarization characteristics of the pulse. Emission luminescence is being induced in the visible range starting with near-infrared light. It is believed that the process is created by two-photon excitation, or it is a nonlinear up-conversion via second harmonic generation and then one photo absorption. Furthermore, the plasmonic waveguide network delivers signals across several tens of micrometers to different discrete locations with nanometer precision. Again, the network or circuit is addressed at a single point using shaped femtosecond pulse in the near-IR, and changes in the phase and/or polarization of the shaped pulses are used to address each separate location wherein there is a local emission of visible light. The system is further operable to serve as a multiplexing encoder/decoder.

Additionally, MIIPS software in the controller measures the chromatic (second and third order phase) dispersion occurring due to the propagation of surface plasmon wave transmission through plasmonic waveguides. For this purpose, a sinusoidal phase is scanned on the incoming laser field and the integrated LSPR emission, after the signal propagates on the waveguide, is detected and collected as a function of the different phase functions. The MIIPS software then automatically analyzes the results and makes the necessary distortion corrections accordingly for subsequently shaped pulses. Moreover, tailored surface plasmon wave waveguides are created that have specific second- and third-order dispersions. Therefore, remote, localized plasmon resonance emissions, microns away from the source, are advantageously created, controlled and applied, by way of example but not limitation, to communications.

While various embodiments have been disclosed herein, it should be appreciated that other modifications may be made that are covered by the system and methods of the present invention. For example, alternate lasers, optics, software, controllers and conductive carriers can be employed as long as they function as described although various advantages of the present invention may not be achieved. Furthermore, a microchip-mounted laser may alternately be used in place of the separate oscillator and fiberoptic cable. The description of the invention is merely exemplary in nature and, thus, variations that do not depart from the gist of the invention are intended to be within the scope of the invention. Such variations are not to be regarded as a departure from the spirit and scope of the invention.

1. A laser system comprising:
a laser beam;
a conductive carrier for the laser beam; and
a pulse shaper operably shaping the laser beam and operably controlling the shaped laser beam to cause light emission downstream of a launching focal point of the laser beam along the carrier.

2. The laser system of claim 1, wherein the carrier comprises an electromagnetically conductive material.

3. The laser system of claim 1, wherein the carrier comprises a metallic wire.

4. The laser system of claim 1, wherein the carrier comprises a series of metallic nanoparticles.

5. The laser system of claim 1, wherein the carrier is part of a microchip circuit.

6. The laser system of claim 1, wherein the laser beam has a pulse duration of 20 femtoseconds or less.

7. The laser system of claim 1, further comprising:
a femtosecond laser operably emitting the laser beam;
the pulse shaper operably modifying and causing nonlinear emission of the laser beam; and
the carrier operably transmitting the shaped laser beam.

8. The laser system of claim 1, wherein the pulse shaper assists in transmitting a surface plasmon wave along the carrier, and the carrier is metallic with at least one dimension being less than 0.1 micrometers.

9. The laser system of claim 1, wherein the emission is at least partially controlled by varying the polarization of the laser beam by the device.

10. The laser system of claim 1, wherein the emission is at least partially controlled by varying the phase of the laser beam.

11. The laser system of claim 1, wherein the emission is at least partially controlled by varying a dispersion characteristic of the carrier.

12. The laser system of claim 1, further comprising:
a programmable controller; and
a characteristic associated with the laser beam is at least partially controlled by using Multiphoton Intrapulse Interference Phase Scan software instructions in the controller.

13. The laser system of claim 1, further comprising a communications receiver operably receiving a communications signal responsive to the laser beam.

14. A laser system comprising a conductor carrying optical plasmonic signals over at least 0.1 micrometer, at least in part due to control of polarization or phase of a laser pulse carried by the conductor, and a communications receiver operably receiving a communications signal responsive to the laser pulse.

15. The laser system of claim 14, wherein the conductor comprises an electromagnetically conductive material.

16. The laser system of claim 14, wherein the conductor comprises a metallic wire.

17. The laser system of claim 14, wherein the conductor comprises at least two metallic nanoparticles.

18. The laser system of claim 14, wherein the conductor is part of a microchip circuit.

19. The laser system of claim 14, wherein the laser pulse has a duration of 20 femtoseconds or less.

20. The laser system of claim 14, further comprising:
a laser oscillator operably emitting the laser pulse; and
a pulse shaper operably modifying and assisting in the control of the laser pulse;
the conductor operably transmitting the shaped laser pulse.

21. The laser system of claim 14, wherein there is a gap in the conductor between a focal point of the laser pulse and emission of the laser pulse located downstream of the focal point.

22. The laser system of claim 14, wherein the laser pulse has a non-linear photonic characteristic.

23. The laser system of claim 14, wherein the conductor acts as a nanoplasmonic waveguide.

24. (canceled)

25. The laser system of claim 14, further comprising a communications transmitter connected to the conductor.

26. A laser system comprising a laser beam and a plasmonic waveguide circuit operably delivering signals to different emitter locations controlled by changes in at least one of the following characteristics: (a) phase of the laser beam, (b) polarization of the laser beam, (c) shape of the laser beam, (d) spectrum of the laser beam, (e) dispersive properties of the conductive waveguides, (f) resonant frequency of an emitter location in the network, (g) particle size of the emitter location, and (h) chemical composition of the emitter.

27. The laser system of claim 26, wherein the characteristic includes phase of the laser beam.

28. The laser system of claim 26, wherein the characteristic includes polarization of the laser beam.

29. The laser system of claim 26, wherein the characteristic includes conductivity of the emitter.

30. The laser system of claim 26, wherein the characteristic includes resonant frequency of the emitter.

31. The laser system of claim 26, wherein the characteristic includes particle size of the emitter.

32. The laser system of claim 26, wherein the characteristic includes chemical composition of the emitter.

33 The laser system of claim 26, further comprising a pulse shaper assisting in control of the laser beam to cause delivery of the signals to the different emitter locations.

34. The laser system of claim 26, further comprising optoelectronics connected to the emitter locations and operably activated by receipt of the signals at the associated emitter locations.

35. The laser system of claim 26, further comprising a communications receiver associated with at least one of the emitter locations.

36. The laser system of claim 26, wherein at least one of the emitter locations is downstream of a focal point of the laser beam.

37. The laser system of claim 26, wherein the circuit includes nanowires made from nanoparticles.

38. A method of operating a laser system, the method comprising:
(a) transmitting at least one laser beam pulse;
(b) causing the laser beam pulse to luminesce remote from a focal point of the laser beam pulse, at a desired remote location; and
(c) shaping the laser beam pulse to assist in obtaining the desired remote location.

39. The method of claim 38, further comprising causing the transmitted EM pulse to induce luminescence at least ten micrometers downstream from the focal point.

40. The method of claim 38, further comprising transmitting the EM pulse with a duration at or less than 20 femtoseconds.

41. (canceled)

42. The method of claim 38, further comprising using the laser beam pulse to create a plasmonic wave along a nanowire circuit.

43. The method of claim 38, further comprising sending communications signals to a communications receiver by use of the at least one beam pulse.

44. The method of claim 38, further comprising controlling the desired remote location from multiple remote location choices by at least one of: (a) varying a characteristic associated with the laser beam pulse, (b) changing the dispersion characteristics of the conductor and (c) using different characteristics associated with the remote location choices.

45. The method of claim 38, further comprising conducting the laser beam pulse along a microchip, the focal point being located on the microchip, and activating an optoelectric component connected to the microchip.

46.-64. (canceled)
